(19) United States
(12) Patent Application Publication
(10) Pub. No.: US 2010/0232649 A1
(43) Pub. Date: Sep. 16, 2010

(54) Locating Device for a Magnetic Resonance System

(76) Inventors: Zhi Cheng Deng, Shenzhen (CN); Chao Ming He, Shenzhen (CN); Jin Qiang He, Shenzhen (CN); Oliver Schreck, Bamberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/720,702

(22) Filed: Mar. 10, 2010

(30) Foreign Application Priority Data
Mar. 12, 2009 (CN) 200920145228.4

(51) Int. Cl. G06K 9/62

(52) U.S. Cl. 382/103; 324/321

(57) ABSTRACT

The present utility model provides a locating device for a magnetic resonance system comprising an image sensor, an image display for displaying images acquired by the abovementioned image sensor, and a locator, which locator has at least one locating mark. There is no need for the abovementioned locating device for a magnetic resonance system to use a laser for locating and, therefore, the case where an operator is hurt by the laser will not occur. On the other hand, due to the use of the image sensor and the image display, the remote control of adjustment conditions can be accomplished, therefore there is no need to repeatedly enter into a magnetic resonance examination room to carry out operations during the adjustment process, which saves time and costs for the adjustments.

### CROSS REFERENCE TO RELATED APPLICATIONS

This application claims priority of Chinese application No. 200920145228.4 filed Mar. 12, 2009, which is incorporated by reference herein in its entirety.

### FIELD OF THE INVENTION

The present utility model relates to a magnetic resonance system and, particularly, to a locating device for a magnetic resonance system.

### BACKGROUND OF THE INVENTION

When a magnetic resonance system is used to carry out a scan examination of a patient, the patient has to be located within a scanning space of the magnetic resonance system. Normally, a magnetic resonance system has a scanning space, and the patient to be scanned lies on a bed board, and then both the bed board and the patient thereon are moved into the scanning space to carry out the scan; and after the completion of the scan, the bed board needs to be moved out of the scanning space.

The abovementioned locating operation requires high precision, and usually the patient needs to be located at just the center of the magnet before being scanned, and more precisely speaking, the affected part to be scanned should be located just at the center of the working magnetic field of the magnetic resonance system, while in the prior art, a laser locator is commonly used to perform the locating operation. In this case, the laser locator will emit a mark with a cross to locate the patient or a coil on the bed board. The normal operation procedure thereof is as follows:

Before starting the system, a locating initialization adjustment needs to be made to the bed board: first, placing a model with a locating mark on the bed board, then moving the bed board so as to move the model to underneath the laser locator, and when the cross mark emitted by the laser locator is overlaps the mark on the model, it indicates that the model has been positioned exactly below the laser locator, and the initial position of the bed board at this time is recorded as a first position; then, moving the bed board into the magnet to move the model into the magnet for repeated scanning and measuring, until the mark on the model is exactly located at the center of the magnet, and the position of the bed board at this time is recorded as a second position; and by comparing the second position with the first position, a horizontal distance of the laser locator from the center of the magnet can be obtained.

During a real scanning process, normally there is a locating mark on a local coil (a surface coil) covering the part of the patient to be scanned, and in a similar way, the bed board is moved first, so as to make the cross mark emitted by the laser locator overlap with the locating mark on the local coil, and then the bed board is moved from this position into the magnet by the distance recorded as mentioned above, so that the affected part of the patient to be examined is exactly at the center of the magnet.

However, there are two defects in the use of the laser for locating; firstly since the output power of a laser locator is typically less than 1 mW and the emitted laser wavelength is about 650 nm, a laser of this specification cannot be viewed directly with the naked eye, and therefore during examination it is necessary to repeatedly warn the patient to be careful about it, but for those noncompliant patients, for example children or unconscious patients, this is hard to do. On the other hand, if the patient needs to be relocated, an operator has to re-enter the scanning room to manipulate the laser locator and move the bed board again, and this not only takes a long time, but also increases the probability of being hurt by the laser.

### SUMMARY OF THE INVENTION

Therefore, a technical problem to be solved by the present utility model is to provide a device for locating a patient in a magnetic resonance system, wherein the device needs no laser for locating, and therefore, there will not be any cases of being hurt by a laser.

Another technical problem to be solved by the present utility model is to provide a remotely controllable locating device, so that adjustment conditions can be achieved by remote manipulation and, therefore, there is no need to enter repeatedly into the magnetic resonance examination room to carry out operations during the adjustment process, thus saving time and costs of the adjustments.

In order to solve the abovementioned technical problems, the present utility model proposes a locating device for a magnetic resonance system, wherein said magnetic resonance system comprises a magnet and a movable bed board, with the magnet having an examination space, and said bed board being movable from outside said magnet into said examination space, and wherein said locating device comprises: an image sensor, which is fixed above said bed board; an image display, which displays images acquired by the abovementioned image sensor; and a locator, which has at least one locating mark, with said locator being fixed below said image sensor and above said bed board.

In this case, said locator is a transparent glass plate, said image sensor is a camera, a video camera or a webcam, and said image sensor and said locator are fixed on said magnet.

Said locating device further comprises a locating mark which is fixed on said bed board.

In addition, said bed board is moved by a remotely controllable driving device.

In the abovementioned locating device for a magnetic resonance system proposed in the present utility model, there is no need to use a laser for locating and, therefore, the case in which an operator is hurt by a laser will not happen. On the other hand, due to the use of the image sensor and the image display, which are in cooperation with the remotely controllable bed board, remote manipulation of the adjustment conditions can be achieved, therefore there is no need to enter repeatedly into the magnetic resonance examination room to carry out operations during the adjustment process, thus saving time and costs of the adjustments.

### BRIEF DESCRIPTION OF THE DRAWINGS

The following accompanying drawings are merely intended to schematically illustrate and explain the present utility model, and are not to limit the scope of the present utility model, wherein,

FIG. 1 shows a schematic diagram of a locating device for a magnetic resonance system according to the present utility model, in which the magnetic resonance system is omitted;

FIG. 2 shows a perspective view of the locating device for a magnetic resonance system according to the present utility model;

FIG. 3 shows the locating status displayed in an image display during an actual examination.

### DETAILED DESCRIPTION OF THE INVENTION

For the technical features, objects and effects of the present utility model to be understood more clearly, the particular embodiments of the present utility model are described herein with reference to the accompanying drawings in which like numerals represent the same parts.

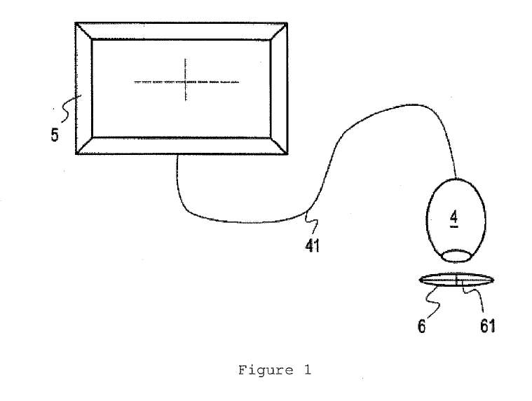

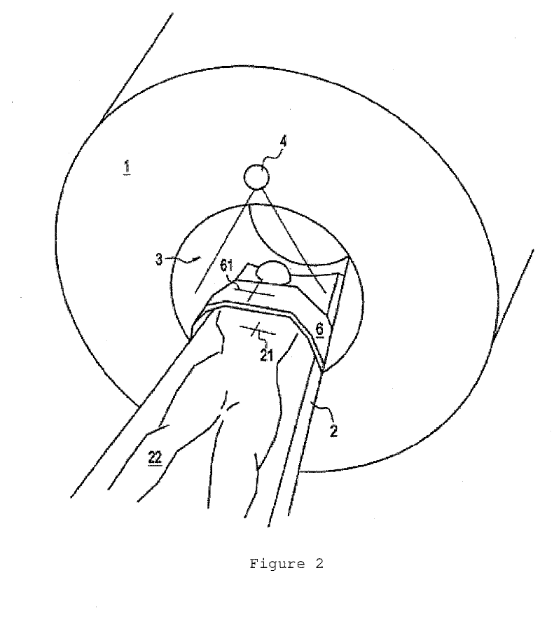

FIG. 1 shows a schematic diagram of a locating device for a magnetic resonance system according to the present utility model, in which the magnetic resonance system is omitted. Said magnetic resonance system can be an open magnetic resonance system, for example, a C-shaped magnetic resonance system, or a closed magnetic resonance system as shown in FIG. 2. The system normally comprises a cylindrical magnet 1 and a movable bed board 2, the magnet 1 having an examination space 3, and said bed board 2 can be driven to move from outside the magnet 1 into the examination space 3 by a remotely controllable driving device (not shown); of course, those skilled in the art will understand that the movement of said bed board 2 can also be manually controlled, and also it can be manipulated at the installation position of the magnetic resonance system by a corresponding driving device.

As shown in FIGS. 1 and 2, the locating device according to the present utility model comprises: an image sensor 4, an image display 5, and a locator 6.

The image sensor 4, which can be a digital camera commercially available on the market, or can be a digital video camera or digital webcam, is fixed on the magnet 1 above the bed board 2, and the image sensor 4 can acquire images of the locator 6 and the bed board 2 therebelow through its optical system (not shown), and the images can be transmitted to the distal image display 5 via a corresponding line 41.

The image display 5 displays images acquired by the abovementioned image sensor 4, and it can be an ordinary cathode ray tube (CRT) display or a liquid crystal display (LCD).

The locator 6 has at least one locating mark 61, and said locator 6 is fixed on the magnet 1 by a joint configuration and is located below said image sensor 4 and above said bed board 2. That is to say, the locator 6 cannot move relative to the position of the image sensor 4, while the bed board 2 is movable relative to the locator 6, and moreover, it is preferable that the locating mark 61 on the locator 6 is exactly below the image sensor 4, to facilitate the locating operation. Of course, the locating mark 61 on the locator 6 can also be located at a position slightly offset from exactly below the image sensor 4, as long as the image of the locating mark 61 can be captured by the optical system of the image sensor 4.

Said locator 6 is of a transparent structure, for example, the locator 6 can be a transparent glass plate or other hard transparent plastic plates, etc. on which there is a cross mark 61, as show in FIG. 2. The reason for the locator 6 to employ a transparent structure is to enable the image sensor 4 to acquire the images of the cross mark 61 on the locator 6 and acquire the images of the bed board 2 or the patient (and a local coil) therebelow through the transparent structure of the locator 6, which will be further described below.

The method for operating the abovementioned locating device for the magnetic resonance system of the present utility model will be described hereinbelow with reference to FIGS. 1 to 3.

Normally, for a magnetic resonance system newly installed or ready to be put into use, it is necessary for the bed board 2 to undergo a locating initialization adjustment before its actual use, and the steps thereof are as follows:

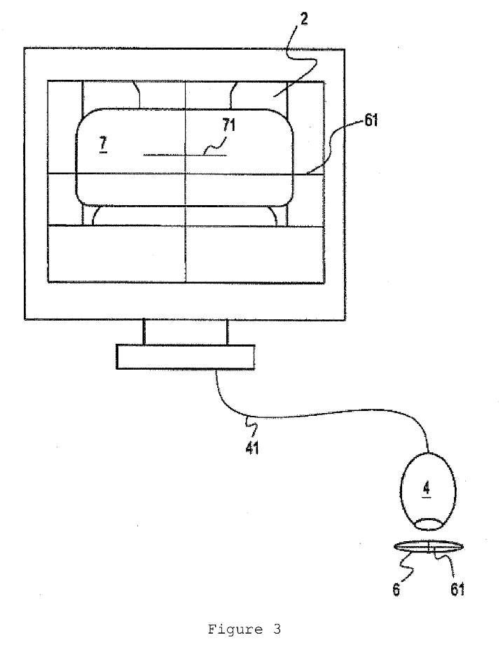

Placing a model 22 having at least one locating mark 21 on said bed board 2, with the model shown in FIG. 2 being the model of a human body, and, of course, it can also be a model in other shapes and its volume can also be relatively small; then, displaying by said display 5 the image of the locator 6 and bed board 2 below said image sensor 4 that is captured by the image sensor 4; next, moving said bed board 2 by remotely controlling a driving device (not shown) of the bed board 2, so as to make the images of said locating mark 21 of said model 22 and said locating mark 61 of said locator 6 overlap on said image display 5, as shown in FIG. 3, and recording the position of said bed board 2 at this time as a first position L1; then, moving said bed board 2 again into said magnet 1 by remotely controlling the driving device of the bed board 2, and making said locating mark 21 on said model 22 located just at the center of said magnet 1 by repeated adjustments, and recording the position of said bed board 2 at this time as a second position L2; finally, acquiring a horizontal distance L of said image sensor 4 from the center of said magnet by comparing said first position L1 with said second position L2, or simply speaking, L=|L2−L1|.

In this specification, the direction in which the bed board 2 enters into and exits the magnet 1 is defined as the horizontal direction, the direction in which the bed board 2 moves up and down is defined as the upright direction, and the direction that is perpendicular to both the abovementioned horizontal direction and upright direction is defined as a left/right direction. It should be noted that, normally for a magnetic resonance system, the movements of the bed board 2 in the upright direction and the left/right direction are limited within the examining space of a magnetic resonance system, which space is quite limited, and, therefore, it is often necessary to determine only the center of the magnet 1, namely a position in the horizontal direction of the center of a working magnetic field. In terms of the present utility model, the abovementioned first position L1 is an initial position in the horizontal direction of the bed board 2, while the second position L2 is a position where the bed board 2 moves to the center of the magnet 1 in the horizontal direction, and, therefore, said second position L2 minus said first position L1 is the horizontal distance L from the image sensor 4 to the center of the magnet 1, that is to say, once the horizontal distance L is known, the distance that the affected part of a patient to be examined should be moved into the magnet 1 is also known, such that it can be exactly positioned at the center of the magnet 1.

In addition, the center of the magnet 1 and the center of the working magnetic field of the magnetic resonance system in this specification actually indicate the same concept, and different names in the text are merely for the convenience of the description, however, in practice, the center of the magnet and the center of the working magnetic field may be slightly different, which will not be described herein in detail.

It is also necessary to point out that the way of adjusting the mark 21 on the model 22 to the center of the magnet 1 can be accomplished by starting up the magnetic resonance system to scan the model 22, for example, by scanning the model 22, so that the position of the mark 21 in the working magnetic field can be obtained, and if an image acquired by scanning indicates that the mark 21 is exactly at the center of the image, then it is known that the mark 21 is exactly at the center of the working magnetic field, namely at the center of the magnet 1.

The abovementioned operation method can be used separately in the adjustment process of the location initialization of the magnetic resonance system, and can also be used during inspection of the magnetic resonance system when the system needs to be repositioned, and its key is to obtain the abovementioned horizontal distance L, so as to facilitate the determination of whether a patient has been moved to a correct position within the magnet 1 when the patient is examined.

In the process of a practical examination of the affected part of a patient to be scanned, it is first necessary to cover the affected part to be examined on said bed board 2 by a coil 7 with at least one locating mark 71, for example, if the head of a patient needs to be scanned, then a head coil needs to cover the patient's head, and normally there is a locating mark on said head coil.

Then, the bed board 2 is moved by remotely controlling the driving device of the bed board 2, so as to make the images of said locating mark 71 of said coil 7 and said locating mark 61 of said locator 6 overlap on said image display 5, and at this time the position of said bed board 2 is recorded as a third position L3.

Finally, said bed board 2 is moved from said third position L3 to said magnet by said horizontal distance L, such that it can be judged whether the affected part to be examined is exactly at the center of the magnet 1.

In the abovementioned locating device for the magnetic resonance system proposed in the present utility model, there is no need to use a laser to carry out the locating operation, and, therefore, the case of an operator being hurt by a laser will not occur. On the other hand, due to the use of the image sensor and the image display, and in cooperation with the remotely controllable bed board, a remote control of the adjustment conditions can be realized, without repeatedly entering into a magnetic resonance examination room to carry out operations during adjustments, which saves time and costs of adjustments.

What are described above are merely schematic embodiments of the present utility model, and are not intended to limit the scope of the present utility model. Any equivalent variation, modification and combination made by those skilled in the art within the concept and principles of the present utility model shall belong to the protective scope of the present utility mode.

1.-7. (canceled)

8. A locating device for a magnetic resonance system comprising a magnet and a movable bed board, comprising:
an image sensor fixed above the bed board that acquires images of a patient;
an image display that displays the images acquired by the image sensor; and
a locator fixed under the image sensor and above the bed board that locates the patient in the magnetic resonance system.

9. The locating device as claimed in claim 8, wherein the locator comprises a transparent structure.

10. The locating device as claimed in claim 9, wherein the locator is a transparent glass plate.

11. The locating device as claimed in claim 8, wherein the image sensor is selected form the group consisting of: a camera, a video camera, and a webcam.

12. The locating device as claimed in claim 8, wherein the image sensor and the locator are fixed on the magnet.

13. The locating device as claimed in claim 8, further comprising a locating mark that is fixed onto the bed board.

14. The locating device as claimed in claim 8, wherein the bed board is moved by a remotely controllable driving device.

15. The locating device as claimed in claim 8, wherein the magnet comprises an examination space and the bed board is moved from outside of the magnet into the examination space.

16. The locating device as claimed in claim 8, wherein the locater comprises a locating mark.
